(19) United States
(12) Patent Application Publication
(10) Pub. No.: US 2010/0199925 A1
(43) Pub. Date: Aug. 12, 2010

(54) PET TOY SYSTEM

(75) Inventor: Betty Lee, San Rafael, CA (US)

Correspondence Address: Bay Area Technolgy Law Group PC, 500 Sansome Street, Suite 404, San Francisco, CA, 94111, US

(73) Assignee: Worldwise Inc., San Rafael, CA (US)

(21) Appl. No.: 12/369,139

(22) Filed: Feb. 11, 2009

(51) Int. Cl. A01K 29/00

(52) U.S. Cl. 119/708; 119/707

(57) ABSTRACT

A pet toy system and kit for the amusement of a domestic pet, such as a cat The system and kit include at least one base, at least one wand having a first end and a second end, the first end being removably affixed to the base. At least one connector is provided being removably affixed to the second end of the wand and a plurality of elongated wires emanating from the connector, each wire supporting a pet attractant toy removably affixed to the ends thereof such that when in use, the weight of the pet attractant toys causes the elongated wires to assume an arcuate shape. The elongated wires and connector are rotatable about the wand by applying lateral force thereto

### TECHNICAL FIELD

The present invention involves a pet toy system as well as a kit for constructing such a system ideal for the amusement of a domestic pet, such as a cat. The kit is provided with various components enabling it to assume a variety of shapes and orientations as the pet owner deems appropriate

### BACKGROUND OF THE INVENTION

Domestic pets, particularly cats, have certain needs which must be met by the pet owner in older to promote the pet's well-being. Cats, which oftentimes are left at home unattended, seek objects which can provide amusement. Cats also have a hunting instinct causing them to swat, pounce and bite upon a foreign object.

There have been others who have suggested amusement devices capable of satisfying some of the above-recognized needs. Fox example, reference is made to U.S. Pat. No. 5,148,769 depicting a suction cup base and extending generally upward and sideward therefrom a wire having a toy removably suspended from it. Although the amusement device of the '769 patent represents an advancement in the field of feline toys, it does present certain inherent limitations, the present invention of which is intended to eliminate. For example, in that the invention of the '769 patent teaches use of an arcuate wire extending directly from a base, as the pet attractant toy suspended from it increases in mass, the wire extending from the toy's base bends at an angle preventing its free rotation. If the attractant toy is of sufficiently heavy mass, the arcuate wire can be bent to such an extent that the toy actually would drag along the floor upon which the base is situated thus eliminating stimulation which such a toy is intended to provide. Furthermore, in not being a kit of parts, one is unable to vary the height of the toy or its physical nature or to provide a handheld embodiment in addition to the base held embodiment depicted therein

It is thus an object of the present invention to provide an improvement over the amusement toy made the subject of the above-referenced '769 patent.

It is yet a further object of the present invention to provide a toy which is capable of stimulating, entertaining and satisfying the hunting instinct of a pet cat while assuming on a number of alternative embodiments greatly expanding its flexibility and thus inherent usefulness.

These and further objects will be more readily apparent when considering the following disclosure and appended claims.

### SUMMARY OF THE INVENTION

A pet toy system and kit for the amusement of a domestic pet, such as a cat. The system and kit include at least one base, at least one wand having a first end and a second end, the first end being removably affixed to the base. At least one connector is provided being removably affixed to the second end of the wand and a plurality of elongated wires emanating from the connector, each wire supporting a pet attractant toy removably affixed to the ends thereof such that when in use, the weight of the pet attractant toys causes the elongated wires to assume an arcuate shape. The elongated wires and connector are rotatable about the wand by applying lateral force thereto.

### BRIEF DESCRIPTION OF THE FIGURES

FIG. 1 is a perspective view of one of the embodiments of the present invention.

FIGS. 2A and 2B are side views of alternative wands useful in practicing the present invention.

FIG. 3 is a top view of a base useful in practicing the present invention

FIG. 4 is a side partially cut away view of a connector useful in practicing the present invention.

FIG. 5 a perspective view of an alternative embodiment of the invention as depicted in FIG. 1.

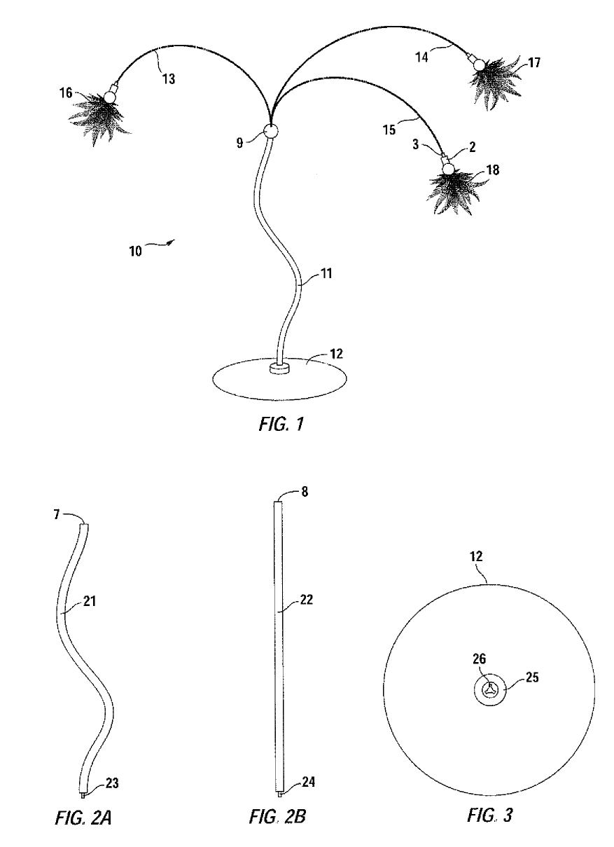

### DETAILED DESCRIPTION OF THE INVENTION

Turning first to FIG. 1, pet toy system 10 is shown illustrating its various component parts as one embodiment thereof.

As noted in reference to FIG. 1, base 12 is provided shown as its preferred embodiment as a suction cup for supporting the remaining elements of the toy system. Base 12, alternatively may be a weighted base although suction cup base 12 enables pet toy system to be supported not only by a horizontal surface but also by vertical or inclined surfaces as well.

An important attribute of the present invention is its ability to facilitate the exchange of various component parts thus expanding its versatility In this regard, it is noted that base 12 includes key slot 26 within raised portion 25. Corresponding projections 23 and 24 located at the first ends of wands 21 and 22, respectively are designed to snap fit within key slot 26 enabling the exchange of wands therein. Thus, wands of different physical shape as well as wands of varying length can be inserted within base 12 and removably exchanged therein. Thus, if attractant toys 16, 17 and 18 removably appended to arcuate wires 13, 14 and 15 are so heavy that a short wand 11 would cause the pet attractant toys to droop to the point of touching a support surface, wand 11 can simply be exchanged for a longer wand thus correcting the defficiency.

As noted, arcuate wires 13, 14 and 15 extend from connector 40 and assume the shape shown in FIG. 1 as a result of the weight imposed upon ends thereof by pet attractant toy 16, 17 and 18, the latter of being any type desired by a user. It has been determined that stainless steel wire of a gauge of approximately 0.020 inches in diameter works best in carrying out the present invention.

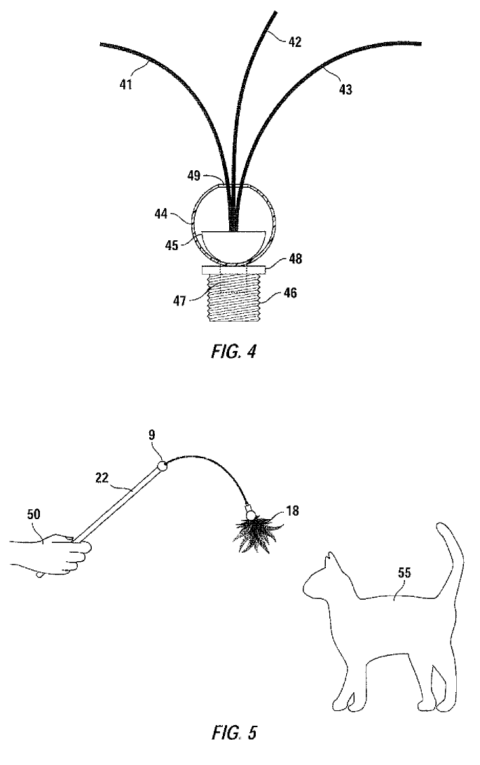

Yet a further feature of the present invention is to facilitate rotation of wires 13, 14 and 15 in that append pet attractant toy 16, 17 and 18 about wand 11 Such a feature enhances the utility of the present invention as a device for stimulating and maintaining the interest of a domestic cat. Cats have a natural tendency to swat at attractant toys such as those depicted in FIG. 1 and the ability of the toys to rotate about wand 11 maintains the interest level of the pet over an extended period of time. FIG. 4 depicts a connector useful in practicing the present invention in order to carry out this design feature.

Turning to FIG. 4, connector 40 is depicted. It is noted that male connector 46 in the form of a threaded cylinder is intended to screw into second or threaded female ends 7 and 8 of wands 21 and 22. Thus, connector 40 can be readily interchanged with other connectors that may have wires of varying length and removable pet attractants of different configurations thus facilitating a quick exchange between parts in order to further stimulate one's pet as well as to exchange parts which are worn or broken. Outer globe 44 having opening 49 allows for the passage of wires 41, 42 and 43 therethrough. These same wires are appended to internal member 45 capable of rotating about support disk 48. Thus, as a cat swats a toy located at the end of one of the arcuate wires 41, 42 of 43, internal member 45 can rotate within support disk 48 and within outer globe 44.

In order to demonstrate the versatility of the present invention, reference is made to FIG. 5 In this instance, wand 22 has been removed from base 12 and held by user's hand 50 Connector 59 has replaced connector 9 (FIG. 1) such that wire 60 emanates therefrom for releasably retaining pet attractant toy 58. Thus, a base-supported pet toy has been converted into a hand-held wand which can be dangled before pet cat 55.

As noted previously, the various pet attractant toys discussed above are each capable of snap fit connection to a supporting arcuate wire. Thus, each attractant toy is intended to have a supporting interface 2 which can have the same key slot opening as shown as element 26 (FIG. 3) for receiving projection 3 (FIG. 1). Thus, as pet attractants are worn or broken or if an owner wishes to simply change pet attractant toys in order to stimulate his or her pet, merely pulling projection 3 from the key slot configured within element 2 can facilitate this function.

What is claimed is:

1. A pet toy system comprising a base, a wand having a first end and a second end, said first end being removably appended to and supported by said base, a connector removably affixed to the second end of said wand, a plurality of elongated wires emanating from said connector, a cat attractant toy removably affixed to ends of each of said elongated wires such that when in use, the weight of said pet attractant toy causes said elongated wires to assume an actuate shape and wherein said elongated wires and connector are rotatable about said wand by applying lateral force to said longitudinal wires.

2. The pet toy system of claim 1 wherein said base comprises a suction cup.

3. The pet toy system of claim 1 wherein a plurality of pet attractants are provided each being interchangeably connected to ends of said wires

4. The pet toy system of claim 1 wherein a plurality of connectors are provided each being interchangeably connected to said wand at its second end.

5. The pet toy system of claim 1 wherein a plurality of bases are provided, each being interchangeably connected to said wand at its first end.

6. The pet toy system of claim 1 wherein said wand is sized to be held by a user once removed from said base for suspending said pet attractant toys proximate a domestic cat.

7. A pet toy kit for the amusement of a domestic cat, said kit comprising at least one base, a plurality of wands each having a first end and a second end and each being removably affixed to said at least one base, at least one connector removably affixed to the second end of each of said plurality of wands, a plurality of elongated wires emanating from each of said at least one connector, a plurality of pet attractant toys each removably affixed to ends of each said plurality of elongated wires such that when in use, the weight of said pet attractant toy causes said elongated wires to assume arcuate shapes and wherein said elongated wires and connectors are rotatable about each of said plurality of wands by applying lateral force to said elongated wires.

8. The pet toy kit of claim 7 comprising a plurality of bases, at least one of which comprises a suction cup

9. The pet toy kit of claim 7 comprising a plurality of connectors each being releaseably attachable to the second end of each of said plurality of wands

10. The pet toy kit of claim 7 wherein at least one of said plurality of wands is sized to be held by a user once removed from said base for suspending said pet attractant toys proximate a domestic pet.
